(19) United States
(12) Patent Application Publication
(10) Pub. No.: US 2011/0153056 A1
(43) Pub. Date: Jun. 23, 2011

(54) Functional Mechatronic Objects

(75) Inventors: Birthe Böhm, Nurnberg (DE); Norbert Gewald, Erlangen (DE); Rudolf Kodes, Oberasbach (DE); Raymond Kok, East Windsor, NJ (US); Thilo Tetzner, Nurnberg (DE)

(73) Assignees: Siemens AG, Munchen (DE); Siemens Product Lifecycle Management Software Inc., Plano, TX (US)

(21) Appl. No.: 12/867,197

(22) PCT Filed: Aug. 31, 2009
(86) PCT No.: PCT/US09/55498

§ 371 Date: Sep. 13, 2010

(51) Int. Cl. G06F 19/00

(52) U.S. Cl. 700/182

(57) ABSTRACT

A method for designing products or industrial systems, wherein comprising the steps of providing software objects representing parts, functions and/or artifacts of the product or the industrial systems are provided, where a software object comprises data for characterizing the software object and interfaces for intercommunication of the software objects and for communication with the environment of the product or the industrial system. The software objects are then assembled by interconnecting the software over the interfaces to design a product or an industrial system.

### PRIORITY CLAIM

This is a U.S. national stage of application No. PCT/US2009/055498, filed on Aug. 31, 2009.

### BACKGROUND OF THE INVENTION

1. Field of the Invention

The invention generally relates to manufacturing systems and, more particularly, to a method, a system, and a computer readable medium for designing products (e.g., camcorders, automobiles, tool machines or roboters) or industrial systems (e.g., power plants), and for engineering manufacturing systems (e.g., production lines or assembly lines) or systems for process industries (e.g., refineries or breweries). The invention is also applicable for engineering automation systems and for engineering solutions for automation problems.

2. Description of the Related Art

Flexibility and re-configurability are the current paradigms which should be considered in product development and in engineering and design of manufacturing systems or systems for process industries, such as oil refineries, chemical plants, or breweries etc. To deal with such requirements, the systems are considered as assemblages of intelligent components (i.e., mechatronic objects) settled in an engineering system, a control framework or a control system. Mechatronic objects can be used for the design of complex manufacturing systems, such as large machinery. In particular, the programming languages and structures defined under the International Electronics Commission (IEC) standard 1131-3 norm are considered regarding software concepts (e.g. data encapsulation) by the design of mechanical systems represented by mechatronic objects. The concept of mechatronic objects is well known. See for example P. F. Muir and J. W. Horner, “Mechatronic objects for real-time control software development”, Proceedings of the 1998 International Symposium on Intelligent Systems (SPIE) and Advanced Manufacturing: Mechatronics Conference, Nov. 5, 1998, Boston.

International Application WO 01/02953 A1 discloses a method and system for integrating an application in a computerized system for representing a real world object, where the real world object is represented by a composite object comprising aspects representing data and/or operations of the composite object. WO 01/02953 A1 does not disclose an efficient way to structure the composite objects according to different topologies, such as for a manufacturing system.

### SUMMARY OF THE INVENTION

It is therefore an object of the present invention to provide an efficient way to structure software objects, i.e., mechatronic objects according to different structures (e.g., topologies, or aspects), also used in complex systems such as manufacturing systems, or process industry.

This and other object and advantages are achieved in accordance with the invention by a method for designing products or industrial systems, comprising the steps of providing software objects representing parts and/or functions and/or artifacts of the product or the industrial systems, where a software object comprises data for characterizing the software object and interfaces for intercommunication of the software objects and for communication with the environment of the product or the industrial system. The software objects are then assembled by interconnecting the software over the interfaces to design a product or an industrial system. Here, the software objects are adapted to be organized according to a first structure of the product or the industrial system and are furthermore adapted to be organized according to a second structure orthogonal to the first structure. In the engineering of industrial systems and plants (e.g., manufacturing systems, power plants or breweries) but also in the product development (e.g., cars, camcorders or mobile phones), the data of different disciplines and roles are grouped along their structures and classification systems. Currently, there is normally a leading aspect for each discipline (e.g., based on mechanical components or functional aspects), after which the data is structured. Through the increased integration of disciplines, or also orthogonal functions, it is also necessary to support orthogonal structures and classification systems in parallel. The present invention provides a way to structure a product or a system without overcrowding the root, which would be cumbersome and inefficient during the engineering process. The invention may be implemented using hardware or software.

In an embodiment of the invention, the software object is a mechatronic object comprising data regarding the disciplines: mechanical engineering, electronic engineering, control engineering, systems design engineering, and computer engineering. As a result, a mechatronic object can be used in all phases of the engineering or design process, and furthermore a mechatronic object encapsulates views and data of these disciplines on a place where they are used. Consequently, these data and views are not scattered but, rather, they are localized in the object.

In another embodiment of the invention, the software object includes different facets, and a facet comprises data for a respective discipline and for discipline spanning information. This supports the design principles of encapsulation and localization of information in an object. This supports also the use of mechatronic objects in all phases of the engineering, design or development process.

In a further embodiment, a first view comprises functional aspects of the product or the industrial system and a second view comprises physical aspects. This allows a parallel and sound structuring of systems or products according to orthogonal aspects, such as security and physical structure.

In another embodiment of the invention, the software objects are adapted to be organized according to a plurality of orthogonal structures. Therefore, complex systems can also be clearly represented and structured by mechatronic objects.

In yet a further embodiment of the invention, the software object comprises a relation to a functional purpose, a relation to a set of software objects adapted to provide said functional purpose and a relation to a set of software objects representing a main structure within the product or within the industrial system. Here, mechatronic objects can be used in systems engineering as real world representatives.

In further embodiments of the invention, the method is applicable for engineering an automation system and/or a solution for an automation problem and/or the engineering of manufacturing systems and/or systems for process industries. The same method and the same toolset (e.g., engineering system or software development environment) for applying the method can be used in a wide range of applications also having different requirements. Consequently, training costs for the developer can be reduced and the infrastructure for the applying the method (e.g., Hardware (HW), computer equipment or engineering system) can be reused in different projects.

Another aspect of the invention is a computer-readable medium, having a program recorded thereon, wherein the program when executed causes a computer to execute the steps of:

providing software objects representing parts and/or functions and/or artifacts of a product or an industrial system to be developed, where a software object comprises data for characterizing the software object and interfaces for intercommunication of the software objects and for communication with the environment of the product or the industrial system; and assembling the software objects by interconnecting them via the interfaces for engineering or designing the product or the industrial system to fulfill given requirements. Here, wherein the software objects are adapted to be structured according to a first aspect of the product or the industrial system and are furthermore adapted to be structured according to a second aspect orthogonal to the first aspect. Computer-readable mediums, such as CDs, floppy disks or USB sticks, are commodities and can be easily distributed between different places and computers. Computer-readable mediums making a computer execute the inventive method steps enables engineering in the field (e.g., on a plant site) and offshore development.

In an embodiment of the computer-readable medium, the software object includes different facets, and a facet mainly comprises data from one of the disciplines mechanical engineering, electronic engineering, control engineering, systems design engineering or computer engineering.

In another embodiment of the computer-readable medium, the computer readable medium is adapted to design an automation system, a solution for an automation problem, a manufacturing system and a system for process industries.

In another embodiment of the invention, a system for engineering products and/or manufacturing systems and/or a system for process industries comprises a providing unit for providing software objects representing components and/or functions and/or artifacts of the manufacturing system and/or the system for process industry and/or products, where a software object comprises data for characterizing the software object and interfaces for intercommunication of the software objects and for communication with the environment of the manufacturing system or the system for the process industry or products.

The system also includes a design unit for assembling the software objects by interconnecting them via the interfaces for engineering the manufacturing system or the system for the process industry or products regarding defined requirements. Here, the software objects are adapted to be structured according a first aspect of the manufacturing system or the system for the process industry or the product and furthermore adapted to be structured according to a second aspect being orthogonal to the first aspect.

Also included is an output unit for presenting the engineered manufacturing system or the system for the process industry or products. The system for performing the method in accordance with the contemplated embodiments of the invention can be built by using commercial off the shelf products (e.g., a PC, a Laptop or a workstation) with monitor, memory, operating system and input devices (i.e., keyboard or mouse) or engineering systems (e.g., for the engineering of automation systems). Furthermore, the method can be performed by using design tools (e.g., CAD tools) for developing products.

In an embodiment, the system comprises a mechanism for reusing the software objects. This allows the design of products and systems in a time-efficient manner.

In another embodiment, the output unit (e.g., display or monitor) of the system is adapted to present different aspects of the assembled software objects. This enables a graphical presentation of views and aspects of a product or a system built up by mechatronic objects. Also a masking or fading out of special views or aspects to the system is possible.

In a further embodiment, a first aspect of the assembled software objects allows the structuring of the software objects according to functional aspects of the manufacturing system or the system for the process industry or products and a second aspect of the assembled software objects allows the structuring of the software objects according physical aspects. This allows the structuring of a product or an industrial system according to orthogonal aspects or views.

Communication in this context comprises direct communication between object or relationships between the objects and their data. Relationships and/or communication can have a defined semantic, e.g., part-of-relation, predecessor-successor-relationship for relationships, such as interrupt controlled communication, direct communication, secure communication, analog communication or discrete communication.

Artifacts in this context comprise requirements specification, design specification, functional specification, test specification, configuration information, parameterization information, and detailed design artifacts for disciplines, such as code listings on wiring diagrams.

### BRIEF DESCRIPTION OF THE DRAWINGS

The above-mentioned and other concepts of the present invention will now be addressed with reference to the drawings of the preferred embodiments of the present invention. The shown embodiments are intended to illustrate, but not to limit the invention. The drawings contain the following figures, in which like numbers refer to like parts throughout the description and drawings, in which:

FIG. 1 is an illustration of a schematic overview diagram depicting a mechatronic object and an exemplary aggregation of mechatronic objects in accordance with the invention;

FIG. 2 is an illustration of an exemplary tree of mechatronic objects comprising a functional mechatronic object in accordance with the invention;

FIG. 3 is an illustration of an exemplary tree of mechatronic objects representing a car air conditioning system in accordance with the invention;

FIG. 4 is an illustration of an exemplary setup of a mechatronic object in accordance with the invention;

FIG. 5 is an illustration of an exemplary instance structure of mechatronic objects and exemplary discipline specific views on aspects of mechatronic objects in accordance with the invention;

FIG. 6 is an illustration of an example for an object oriented representation of a mechatronic object in accordance with the invention;

FIG. 7 is an illustration of the use of mechatronic integration in an exemplary engineering workflow; and

FIG. 8 is an illustration of an exemplary system for implementing and using the method in accordance with the invention.

### DETAILED DESCRIPTION OF THE PREFERRED EMBODIMENT

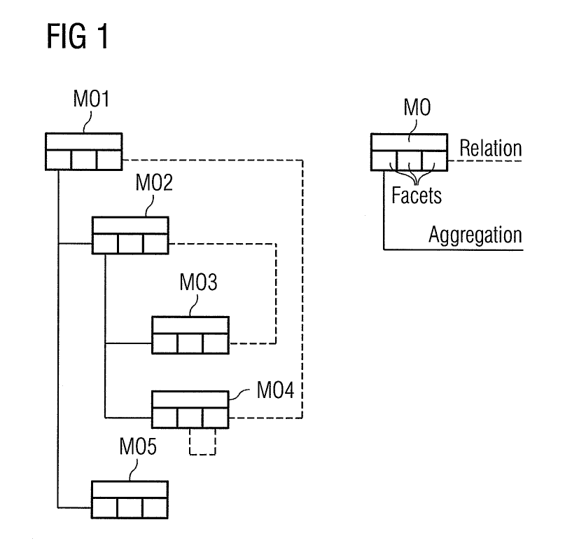

It will be readily understood that the components of the present invention, as generally described and illustrated in the Figures herein, may be arranged and designed in a wide variety of different configurations. Thus, the following more detailed description of the embodiments of the present invention, as represented in FIGS. 1 through 5, is not intended to limit the scope of the claimed invention, but is merely representative of selected embodiments of the invention.

Mechatronics is the synergistic combination of mechanical engineering, electronic engineering, control engineering, systems design engineering, and computer engineering to create useful products or systems (e.g., manufacturing systems or systems for process industries or consumer products). This interdisciplinary engineering approach supports especially the design of hybrid systems comprising different disciplines (e.g., data processing, mechanics or electronics). Furthermore, this approach allows the generation of simpler, more economical, reliable and versatile systems. The main concept of this engineering approach is the concept of mechatronic objects. Mechatronic objects are software objects and support the paradigms of object oriented programming and system development, i.e., inheritance, encapsulation, instantiation and/or class concept.

FIG. 1 shows a schematic overview diagram illustrating a mechatronic object (MO) and an exemplary aggregation MO1 to MO5 of mechatronic objects. In engineering of industrial systems and plants but also in the product development the data of different disciplines and roles are grouped along their structures and classification systems. Right now, there is normally a leading aspect for each discipline (e.g., based on mechanical components or functional aspects), after which the data is structured. Through the increased integration of disciplines or also orthogonal functions, it is also necessary to support orthogonal structures and classification systems in parallel. The exemplary aggregation of mechatronic objects MO1 to MO5 is normally performed according to a main structure or a classification system. Here, a facet normally describes data for one discipline (e.g., data processing, mechanics or electronics).

To support a leading structure to integrate all the different disciplines, a concept of mechatronic objects is established. A mechatronic object MO can include different facets, e.g., one facet for each discipline. The facets contain the data for a discipline, while the MO-structure aggregates (MO1 to MO5) and connects the data. An mechatronic object MO describes an element in engineering, like a machine. If the machines are integrated in an assembly line, the mechatronic objects of the machines can be aggregated in a parent mechatronic object for the assembly line. The concept normally depends on the mechatronic objects having defined interfaces which can be interconnected, so that encapsulation of information is possible. With the connection of interfaces, another important requirement for mechatronic engineering is fulfilled.

For functions that are orthogonal to the mechatronic object structure, such as security issues or when the functional breakdown does not go along with the physical breakdown, an extended concept is needed. It is only then that these orthogonal functions or alternative structures can be tracked and visualized and, therefore, all disciplines can be supported optimally. In these cases the functions are scattered over the leading mechatronic object tree. Consequently, the relation of the function to the mechatronic objects helps to identify the parts of the plant belonging to a function. However, there is information that belongs more to a function than to the related mechatronic objects, such as a security function which influences different parts of the system. The problem here is where to place this information.

A similar problem occurs with the decomposition of a system in subsystems. Often a system can be decomposed in different ways, but the main structure only allows one way. The other possibilities may still be relevant. For example, a plant can be decomposed using the levels plant, line, cell and machine or it can be structured according to systems such as pneumatic system, air conditioning system or safety system.

The orthogonal information can be put on the highest mechatronic objects level MO1 where all the function related mechatronic objects are aggregated, which means in most cases that they will be put at the root node. The root node MO1 will thus be crowded with parallel functions that are related to the subordinated mechatronic objects MO2-MO5.

Another way of dealing with these issues is to ignore them. The different functions and structures are neglected and are only implicitly present in the engineering data. The skilled engineer can still handle them, but they are not represented in any structuring and errors due to this invisibility are common.

Concerning reuse the orthogonal structures are modeled independently and are not closely coupled. Combined reuse over the different structures is also hard to realize because the different disciplines think in different structures and cannot agree on one common structure.

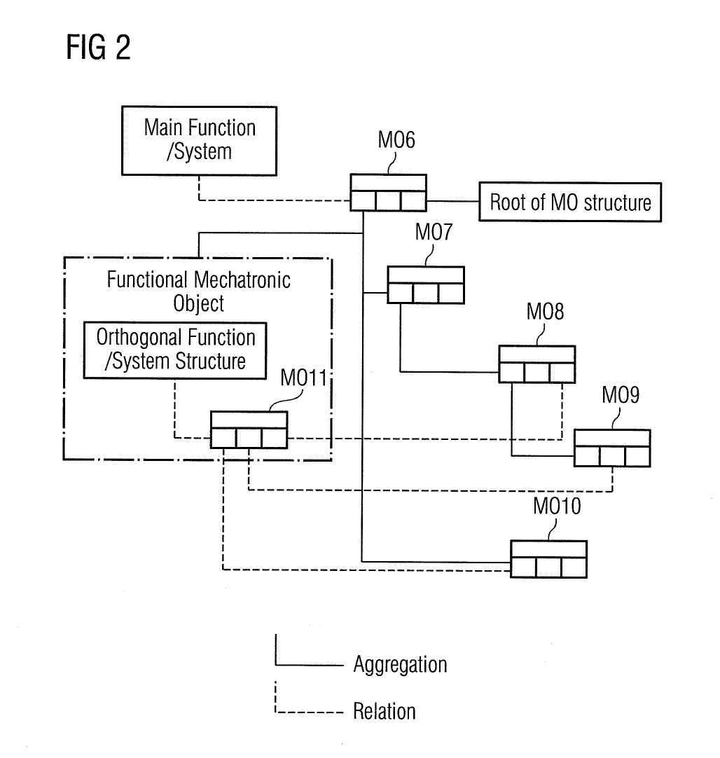

FIG. 2 shows an exemplary tree of mechatronic objects comprising a functional mechatronic object MO11. To avoid overcrowding, the root node MO6 (i.e., the function specific information), which still belongs to the mechatronic object level, should be assigned explicitly to an according function. Consequently, new intermediate objects between the function and the mechatronic objects are created (i.e., Functional Mechatronic Object (FMO) MO11). The Functional Mechatronic Object MO11 is a mixture of both worlds. The Functional Mechatronic Object MO11 forms a part of the functional breakdown and is so related to a function. Also, MO11 is a part of the mechatronic plant structure. Still, they can be separated in a clear functional description and the belonging information aspects (facets) and relations for handling reasons, but they still build up one logical object.

In summary, the mechatronic object is normally structured according to the main purpose of the plant, e.g., the production process. Orthogonal functions (e.g., air conditioning) and their information can be separately modeled with functional objects. By doing this, the main structure of the mechatronic object tree MO6 to MO10 can be maintained in relatively good shape. The dotted line in FIG. 2 presents a relationship between objects, and the solid lines present an aggregation of objects.

Technically, the Functional Mechatronic Object MO11 consists of three main parts: the relation to the functional purpose, the aggregated mechatronic object part for the purpose and the parts of the main structure belonging to the Functional Mechatronic Object MO11. As a result, a clear definition of all parts belonging to the orthogonal function is provided. The functional purpose and the aggregated mechatronic object part can be directly integrated in the Functional Mechatronic Object MO11, and they can be sub-structured for themselves. The parts residing in the main structure have to be related to the Functional Mechatronic Object MO11. In addition, clear interfaces between the related and the non-related parts in the main structure should be defined to really separate the concerns.

The functional part can include the specification and description of the functional intent. This may be text or diagrams. The other parts of the Functional Mechatronic Object MO11 consist of building blocks of the mechatronic object structure, e.g. mechatronic objects, facets or parts of the structure, interfaces and the relation between all these building blocks.

The orthogonal functions can be reused as one part and stored in libraries. For doing this, it is important that partial mechatronic objects and their facets can be extracted out of the mechatronic object structure. The clear separation allows the reuse of the Functional Mechatronic Object MO11. During instantiation, this partial information must be added and connected to the new mechatronic object structure. This can be achieved, for example, manually, according to classifications or by given rules.

This can lead to different scenarios, e.g., that complete mechatronic objects or mechatronic objects with only one or that only facets or parts of facets are extracted and reinstantiated. It is important to know the relation and interfaces of the extracted parts to be able to instantiate them correctly by hand or automatically.

The described Functional Mechatronic Object MO11 can not only be applied to functional structuring but to, e.g., system structuring. A system can be decomposed according to different structuring methods. Instead of applying the Functional Mechatronic Object MO11 to an orthogonal functional breakdown, it can be applied to an orthogonal system breakdown (e.g., different system breakdowns for different disciplines).

Preferably, the described method is supported by a tool to guide and support engineers. Here, the tool should allow defining the Functional Mechatronic Objects inside an mechatronic object structure. It then should be possible to visualize a Functional Mechatronic Object in the mechatronic object structure, which is like a filtering function in a tool. The tool should further support the extraction of the Functional Mechatronic Object MO11 to a library and support the instantiation. The extraction and instantiation process should be guided by a tool to give the engineer support how to define correct interfaces and relations and how to reconnect them after instantiations. For validation support, unconnected interfaces or undefined connections can be found and displayed by a tool.

In accordance with the invention, elements of the main structure belonging to an intent in an Functional Mechatronic Object MO11 are aggregated and connected to the intent.

Advantages of the concept of Functional Mechatronic Objects are:
An intent can be entirely visualised. All relevant parts of a function or orthogonal system can be filtered and visualized. This helps engineers to get an overview if the function or orthogonal system is complete and valid. Especially if the system is redesigned and altered while engineering it is useful to check if all functions and orthogonal systems still are correct.
The dependencies are known between the mechatronic object structure and the Functional Mechatronic Objects. While changes occur, the engineers can see more easy which functions are affected.
When using Functional Mechatronic Objects in reuse, the function or orthogonal system is already tested and all the relations are set. This should lead to fewer errors in engineering.

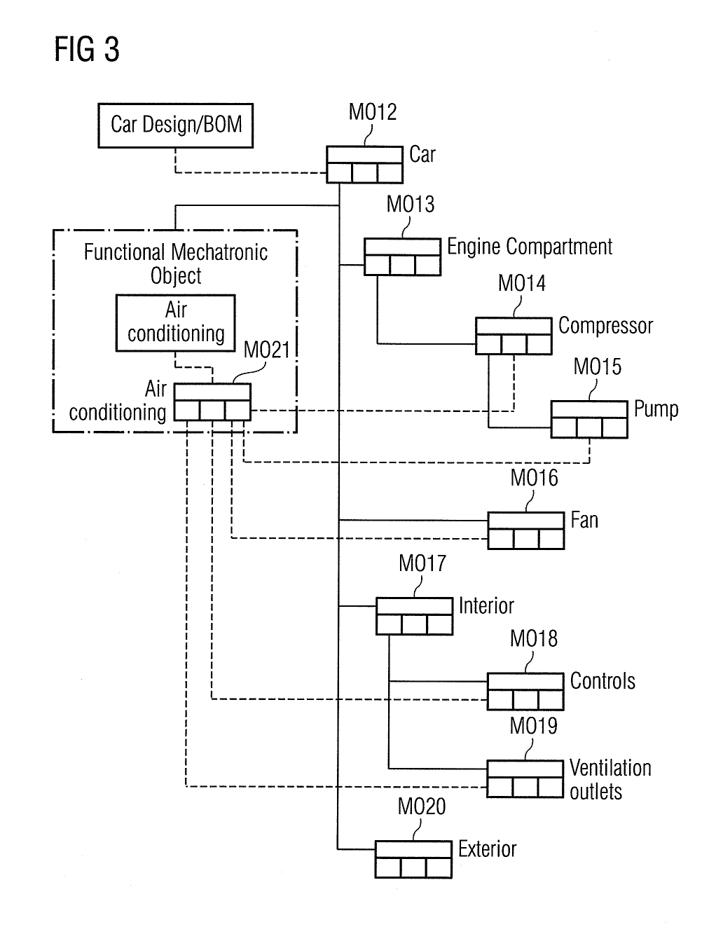

FIG. 3 shows an exemplary tree of MO21 representing a car air conditioning system. The mechatronic object MO12 represents the root of the system, i.e., the car. The mechatronic objects MO13 to MO20 show an aggregation to build the physical structure of the car. In engineering, the data of a car could be structured in the areas where the components are mounted, e.g., engine compartment, interior or exterior. The mechatronic object structure on the right depicts such a structuring, only showing elements used for the air conditioning system. The structure would be filled with much more elements in the different sub-structures.

The Functional Mechatronic Object (FMO) MO21 on the left side relates all the needed parts for air conditioning and adds top level data. Consequently, all data for the air conditioning system is known and, e.g., could be moved to a library for reuse, could be filtered for better viewing or used for requirements tracing. Nevertheless, the given main structure is untouched and further Functional Mechatronic Objects could be added.

In detail some points are explained. For example, the functional description is contained in an FMO as an encapsulated structure. There may be text explaining the function or there may be diagrams defining it. The data is stored in the Functional Mechatronic Object MO21 and is related to the system part of the Functional Mechatronic Object MO21 which contains the aggregated mechatronic object data of the function air conditioning. This can be the overall signal connection over the communication bus concerning the signals for the air conditioning function. Also, the software executing the control of the air conditioning function belongs to the function, but the software is located as data storage at the controls, because the controller which is running the software is integrated in the controls. The controller and the controls are also used to play radio and music, check the car status or navigation. Consequently, only the software for controlling the air condition function is related to the Functional Mechatronic Object MO21. For reuse the software should be encapsulated so it could be extracted and re-instantiated.

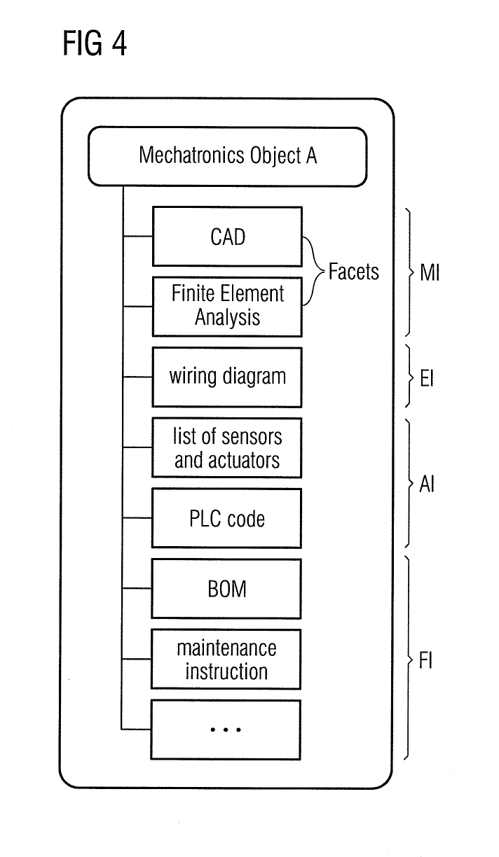

FIG. 4 shows an exemplary setup of a mechatronic object comprising several facets. A mechatronic object represents a container for collecting information over the entire lifecycle of a product or an industrial system. The mechatronic object A in FIG. 4 comprises mechanical information MI (CAD, FEM), electrical information EI (wiring diagram), automation information AI (PLC code) and further information FI (BOM i.e. Bill of Material, Maintenance Instructions, etc). The facet “list of sensors and actuators” is partly electrical information EI and partly automation information AI. It is possible to have several facets for the same domain or discipline and/or to have one facet supporting different domains or disciplines. Therefore, a mechatronic object does not have a fixed number of facets. The number of facets depends on the amount of data and therefore has to be extendable all over the lifecycle of a product (e.g., car or camcorder) or a plant (e.g., power plant).

The mechatronic concept spans a multi-dimensional space having lifecycle aspects, having structural aspects and having information aspects. Therefore, an enrichment of information going along with structuring of information over the lifecycle is provided.

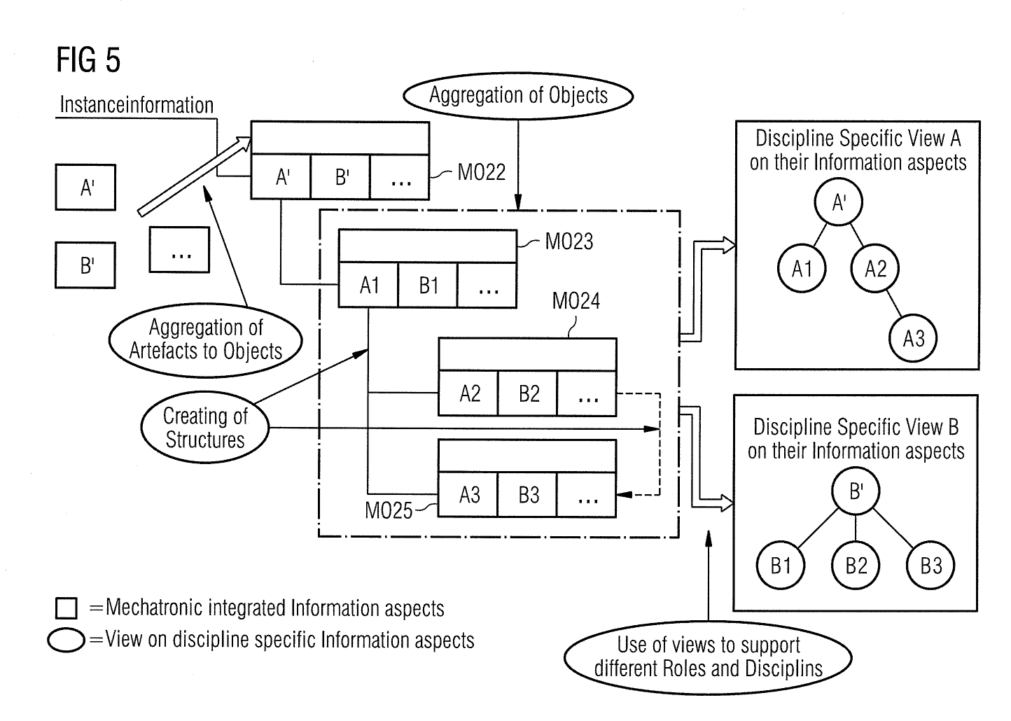

FIG. 5 shows an exemplary instance structure of mechatronic objects and exemplary discipline specific views on aspects of mechatronic objects. The mechatronic object MO22 is the root of a tree of mechatronic objects MO22 to MO25. The root object MO22 and objects MO23 to MO25 in the aggregation can be object types, but also instances of these object types (class concept of the object oriented paradigm). The mechatronic object MO22 is built by an aggregation of artifacts A′, B′ etc. Artifacts can be project, system or product specific documentation (e.g., requirement specification, design specification, program listings or test specification) or other related information. The tree structure can represent a physical layout of the product or the system to be designed. The mechatronic objects MO23 to MO25 inside the dashed box build an aggregation representing a specific solution or a part or subpart of a product or an industrial system. Mechatronic objects provide interfaces and data encapsulation and therefore can be designed separately and combined together by a build.

On the right hand side of FIG. 5 discipline specific views or aspects of the mechatronic objects MO22 to MO25 of the tree are shown. The views and the artifacts belonging to a specific view are each presented as a tree (A′,A1,A2,A3 and B′,B1,B2,B3). A discipline specific view can be for instance: electrical engineering, mechanical engineering, automation design, maintenance, security etc. In the engineering process, a mechatronic object, but also discipline specific views can be designed separately. Therefore, the concept of mechatronic objects also supports “functional engineering”. The concept presented in FIG. 5 allows the integration of mechatronic objects and views into existing lead or main structures and also supports the migration of existing systems (e.g., from third party supplier) in a lead or main structure. This provides the following benefits: reduction of complexity, assurance of consistency, high reusability on object and on system level, and disseminating and integrating of work results in a structured and controlled way.

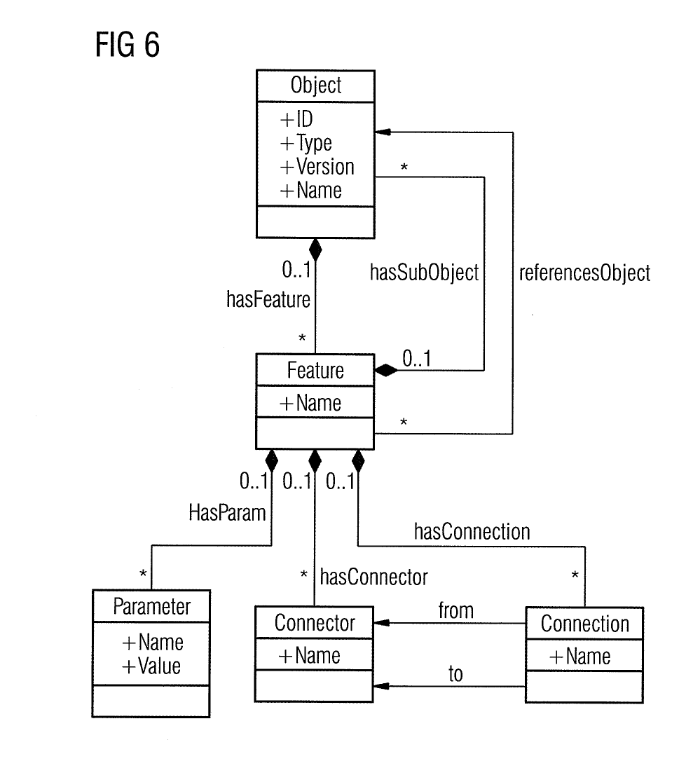

FIG. 6 shows an example for an object oriented representation of a mechatronic object using universal mark-up language (UML) or another object oriented notation. Mechatronic objects can be designed and implemented using engineering systems or software development environments supporting the object oriented paradigm (e.g., classes, types, inheritance or encapsulation). These tools are commodities. FIG. 6 shows in rectangles the involved objects and the parts of objects and the relationships (“is a”, “has”, “from, “to” etc.) between objects or parts of objects respective between parts of objects. By implementing the mechatronic concept, framework formats and specific formats are used. A framework format is an integration basis for different domains and disciplines integrating the specific formats. A specific format comprises information and relationships of a specific domain or discipline.

PLM XML, AutomationML, CAEX or STEP can be used as data formats for a framework format. JT, Collada, PLCopen XML, STEP AP214, AP 210, eClass or ProList can be used as data formats for a specific format.

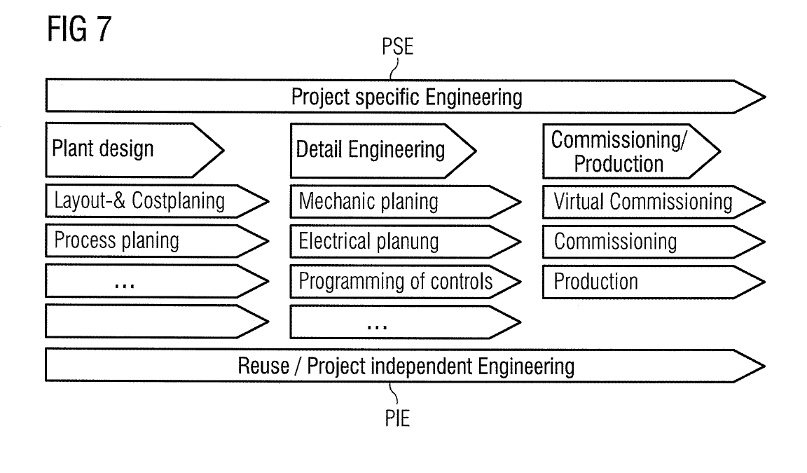

FIG. 7 shows the use of mechatronic integration in an exemplary engineering workflow. Mechatronic objects can be used in project specific engineering (PSE), e.g., in the phases plant design, detail engineering and commissioning/production and in project independent engineering (PIE). Benefits in project specific engineering are, among others, reduction of complexity by encapsulation of the information and the semantic description of interfaces. Benefits in the phase plant design are, among others, the continuous use of structures and data from design. Benefits in the phase detail engineering are, among others, parallel engineering (e.g., by integrating and creating craft respective trade specific views). Benefits in the phase commissioning/production are, among others, use of simulation, test, and validation of results.

Benefits of mechatronic objects in the project independent engineering (PIE) workflow are among others improved reusability of work results by providing and using libraries of types of mechatronic objects and by applying object oriented instantiation concepts (types, templates etc).

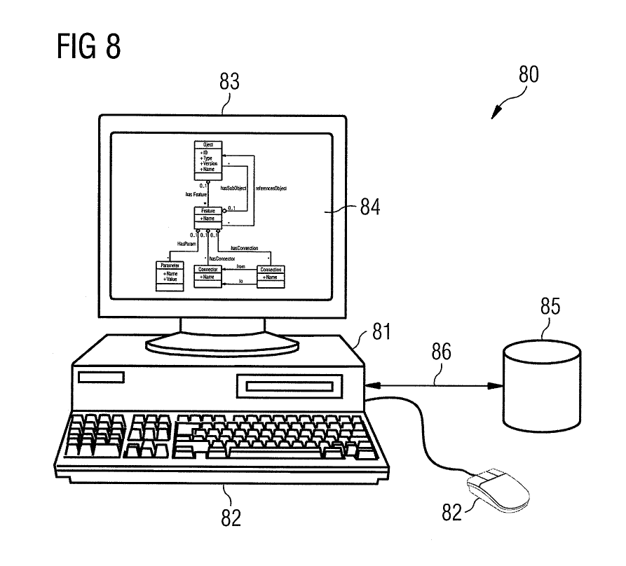

FIG. 8 shows an exemplary system 80 for implementing and using the method in accordance with the invention. The system 80 comprises a processing unit 81 (e.g. Computer, PC, Laptop), an input device 82, (e.g. keyboard and/or mouse), an output unit 83 (e.g., monitor, display) and a device for storing data 85 (e.g., data base, memory). The system 80 can be connected to other systems for distributing data electronically. The illustration on the monitor shows a diagram 84 representing an object oriented structure of a mechatronic object. Mechatronic objects and systems built up by mechatronic objects can be created by using engineering systems or software development environments supporting object oriented paradigms. The storing of mechatronic objects in libraries and allowing the access to these libraries to others increases the reusability of mechatronic objects. This furthermore reduces development costs and provides better time-to-market in product development and design of industrial systems (e.g., manufacturing systems or plants for process industries). The data communication 86 between the processing unit 81 and a storing device 85 can be realized by a wireless connection or by a wired communication line. The method in accordance with the invention can be performed online or by offline communication with a storing device 85 (e.g. project or product data base).

In engineering of industrial systems and plants but also in the product development the data of different disciplines and roles are grouped along their structures and classification systems. Right now, there is normally a leading aspect for each discipline (e.g., based on mechanical components or functional aspects), after which the data is structured. Through the increased integration of disciplines or also orthogonal functions, it is also necessary to support orthogonal structures and classification systems in parallel. To support a leading structure to integrate all the different disciplines, a concept of mechatronic objects is established. A mechatronic object can include different facets, e.g., one facet for each discipline. The facets contain the data for a discipline, while the mechatronic object structure aggregates and connects the data. A mechatronic object describes an element in engineering, like a machine. If the machines are integrated in an assembly line, the MOs of the machines can be aggregated in a parent mechatronic object for the assembly line. The concept normally depends on the MOs having defined interfaces which can be interconnected, so that encapsulation of information is possible. With the connection of interfaces, another important requirement for mechatronic engineering is fulfilled. A Functional Mechatronic Object (FMO) is introduced to provide a plurality of orthogonal aspects and views to a product or system built up by mechatronic objects.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A method for designing a product or an industrial system, comprising the following steps:
providing software objects representing at least one of parts, functions and artifacts of one of the product and the industrial system, a software object comprising data for characterizing the software object and interfaces for intercommunication of the software objects and communication with an environment of the one of the product and the industrial system;
assembling the software objects by interconnecting said software objects through the interfaces to design the one of the product and the industrial system, the software objects being configured for organization according to a first structure of the one of the product and the industrial system and being configured for organization according to a second structure orthogonal to the first structure.

17. The method according to claim 16, wherein the software object is a mechatronic object comprising data regarding disciplines including a mechanical engineering discipline, an electronic engineering discipline, control engineering discipline, a systems design engineering discipline and a computer engineering discipline.

18. The method according to claim 16, wherein the software object includes different facets, and wherein each of the facets comprises data for a respective one of the disciplines and for discipline spanning information.

19. The method according to claim 17, wherein the software object includes different facets, and wherein each of the facets comprises data for a respective one of the disciplines and for discipline spanning information.

20. The method according to claim 16, wherein the first structure comprises functional aspects of the product or the industrial system and the second structure comprises physical aspects.

21. The method according to claim 16, wherein the software objects are configured for organization according to a plurality of orthogonal structures.

22. The method according to claim 17, wherein each of the software objects comprises:
a relation to a functional purpose;
a relation to a set of software objects configured to provide the functional purpose; and
a relation to a set of software objects representing a main structure within one of the product and the industrial system.

23. The method according to claim 17, wherein the method is applicable for engineering one of an automation system and a solution for an automation problem.

24. The method according to claim 17, wherein the method is applicable for engineering at least one of manufacturing systems, and systems for process industries and products.

25. A computer-readable medium encoded with a computer program executed by a computer that causes design of a product or an industrial system, the computer program comprising:
program code for providing software objects representing at least one of parts, functions and artifacts of one of the product and the industrial system, a software object comprising data for characterizing the software object and interfaces for intercommunication of the software objects and communication with an environment of the one of the product and the industrial system; and
program code for assembling the software objects by interconnecting said software objects through the interfaces to design the one of the product or the industrial system, the software objects being configured for organization according to a first structure of the one of the product and the industrial system and being configured for organization according to a second structure orthogonal to the first structure.

26. The computer-readable medium according to claim 25, wherein the software object include different facets, and wherein each of the facet comprises data from one of a mechanical engineering discipline, an electronic engineering discipline, a control engineering discipline, a systems design engineering discipline and a computer engineering discipline.

27. The computer-readable medium according to claim 25, wherein the computer readable medium is configured to design at least one of an automation systems, a solution for an automation problem, a manufacturing system, a system for process industries and products.

28. A system for engineering at least one of a product, a manufacturing system and system for process industries, comprising:
a providing unit configured to provide software objects representing at least one of components, functions, and artifacts of the at least one of the products, the manufacturing system, and the system for process industry, each of the software objects comprising data for characterizing the each of the software objects and interfaces for intercommunication of the software objects and for communication with an environment of the one of the product, the manufacturing system, and the system for the process industry;
a design unit configured to assemble the software objects by interconnecting the software objects through the interfaces to engineer the one of the product, the manufacturing system, and the system for the process industry of defined requirements, the software objects being configured to be structured according to a first aspect of the one of the product, the manufacturing system, and the system for the process industry, and further being configured to be structured according to a second aspect orthogonal to the first aspect; and
an output unit for presenting the engineered one of the product, the manufacturing system, and the system for the process industry.

29. The system according to claim 28, wherein the system comprises a mechanism for reusing the software objects.

30. The system according to claim 28, wherein the output unit is configured to present the different first and second aspects of the assembled software objects.

31. The system according to claim 29, wherein the output unit is configured to present the different first and second aspects of the assembled software objects.

32. The system according to claim 28, wherein the first aspect allows structuring of the software objects according to one of functional aspects of the one of the product, the manufacturing system, and the system for the process industry, and the second aspect allows the structuring of the software objects according to physical aspects.
